(19) United States
(12) Patent Application Publication
(10) Pub. No.: US 2025/0178337 A1
(43) Pub. Date: Jun. 5, 2025

(54) RECORDING DEVICE

(71) Applicant: CANON KABUSHIKI KAISHA, Tokyo (JP)

(72) Inventors: KAI IGARASHI, Kanagawa (JP); SHINICHIRO MATSUMOTO, Kanagawa (JP); KAZUKI KURATA, Tokyo (JP)

(21) Appl. No.: 18/952,064

(22) Filed: Nov. 19, 2024

(30) Foreign Application Priority Data
Dec. 1, 2023 (JP) 2023-203914

(51) Int. Cl. B41J 2/045

(52) U.S. Cl. CPC B41J 2/0451; B41J 2/0455; B41J 2/04581; B41J 2/04588

(57) ABSTRACT

Provided is a recording device including an amplifier unit amplifying and outputting residual vibration voltage, and a setting unit setting an amplification factor of the residual vibration voltage by the amplifier unit, wherein the amplifier unit includes an operational amplifier, a first resistor connected to the operational amplifier, a plurality of switches, and a plurality of second resistors having different resistance values and connected to the operational amplifier via each of the plurality of switches, the recording device includes a selection unit selecting any one of the plurality of switches in accordance with the amplification factor set by the setting unit so as to connect any one of the plurality of second resistors to the operational amplifier, and the amplifier unit amplifies the residual vibration voltage with an amplification factor according to a resistance ratio between the first resistor and the second resistor selected by the selection unit.

### BACKGROUND OF THE INVENTION

### Field of the Invention

The present invention relates to an inkjet recording device.

### Description of the Related Art

Among inkjet recording devices, there is an inkjet recording device that is equipped with a recording head that ejects ink by driving a piezoelectric element, and performs recording using the ink ejected by the recording head. A technology has been proposed that detects anomalies in each nozzle by detecting and analyzing residual vibration voltage caused by residual vibration that occurs after driving a piezoelectric element. Japanese Patent Application Publication No. 2004-50824 proposes a circuit that amplifies and analyzes residual vibration voltage using an operational amplifier. However, in Japanese Patent Application Publication No. 2004-50824, an amplification factor of a circuit that amplifies the residual vibration voltage is fixed. As a result, it is not possible to obtain signal amplitude required to analyze the residual vibration voltage, which changes depending on environment surrounding an inkjet head and a state of ink, and it is sometimes not possible to detect anomalies in a nozzle. In Japanese Patent Application Publication No. 2017-24274, a first resistor and a second resistor are provided for switching an amplification factor of a circuit that amplifies residual vibration voltage, and each of the first resistor and the second resistor includes a plurality of resistive elements, and the amplification factor is switched by changing the number of resistors.

However, the technology described in Japanese Patent Application Publication No. 2017-24274 has a complex circuit configuration, which may lead to increased costs.

### SUMMARY OF THE INVENTION

The present invention provides a recording device that is simply configured and capable of switching an amplification factor of a circuit that amplifies residual vibration voltage caused by a residual vibration after driving of a piezoelectric element.

The present invention is a recording device including a piezoelectric element and a recording head ejecting liquid by driving the piezoelectric element, and performing recording by the liquid ejected by the recording head, the recording device comprising: an amplifier unit amplifying and outputting residual vibration voltage caused by residual vibration generated in the piezoelectric element after the piezoelectric element is driven by a drive signal; and a setting unit setting an amplification factor of the residual vibration voltage by the amplifier unit, wherein the amplifier unit includes, an operational amplifier, a first resistor connected to the operational amplifier, a plurality of switches, and a plurality of second resistors having different resistance values and connected to the operational amplifier via each of the plurality of switches, the recording device includes a selection unit selecting any one of the plurality of switches in accordance with the amplification factor set by the setting unit so as to connect any one of the plurality of second resistors to the operational amplifier, and the amplifier unit amplifies the residual vibration voltage with an amplification factor according to a resistance ratio between the first resistor and the second resistor selected by the selection unit.

Further features of the present invention will become apparent from the following description of exemplary embodiments with reference to the attached drawings.

### BRIEF DESCRIPTION OF THE DRAWINGS

FIG. 1 is a diagram illustrating an overall configuration of a recording device;

FIG. 2 is a schematic diagram illustrating a unit of a recording head;

FIG. 3 is a diagram illustrating the recording head;

FIG. 4 is a schematic diagram illustrating an example of wiring of the recording head;

FIG. 5 is a schematic diagram illustrating another example of the wiring of the recording head;

FIG. 6A is a diagram illustrating a method of driving a piezoelectric element;

FIG. 6B is a diagram illustrating a drive signal for the piezoelectric element;

FIG. 7 is a diagram illustrating a functional configuration of the recording device;

FIG. 8 is a diagram illustrating an image processing unit;

FIG. 9 is a diagram illustrating a drive signal selection unit;

FIG. 10 is a diagram illustrating serial communication;

FIG. 11 is a timing chart of the drive signal selection unit;

FIG. 12 is a diagram illustrating an example of an amplifier circuit that generates a signal for ink ejection;

FIG. 13 is a diagram illustrating a residual vibration voltage;

FIG. 14 is a diagram illustrating a residual vibration voltage detection circuit of a comparative example;

FIG. 15 is a diagram illustrating a residual vibration voltage detection circuit of an embodiment; and

FIG. 16 is a diagram illustrating a correspondence relationship between input data and gain of a switch selection unit.

### DESCRIPTION OF THE EMBODIMENTS

Illustrative forms for carrying out the present invention will be described below with reference to the drawings. However, dimensions, materials, shapes, and relative arrangements of the components described in following embodiment should be modified as appropriate depending on configuration and various conditions of a device to which the present invention is applied, and are not intended to limit the scope of the present invention to the following embodiment.

### Overall Configuration of Recording Device

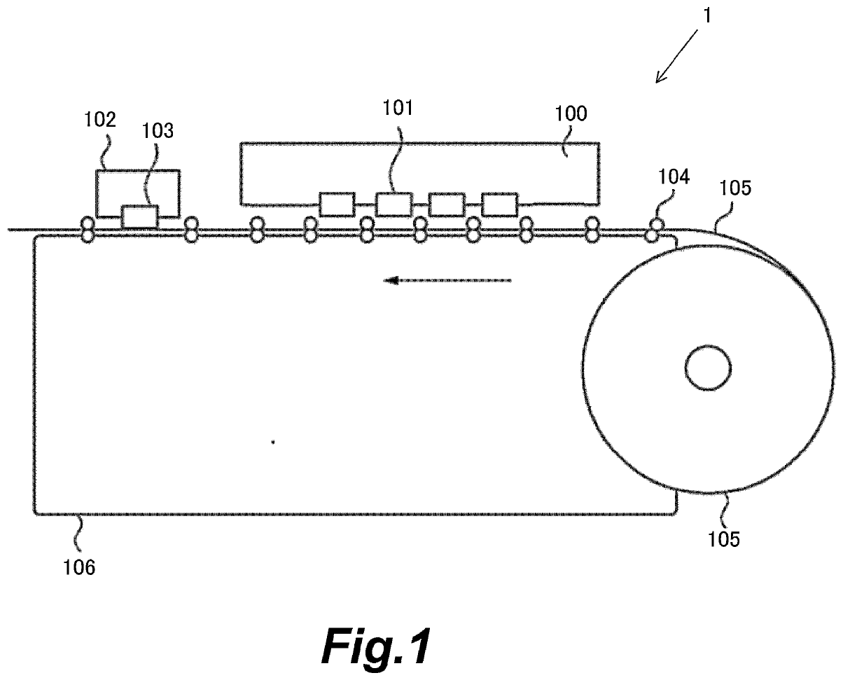

FIG. 1 is a side cross-sectional view illustrating a configuration of a recording device 1 that uses a full-line inkjet recording head to record on a roll-shaped recording medium such as roll paper, as an example of an inkjet recording device. A full-line inkjet recording head (hereinafter referred to as a “recording head”) is a recording head with a recording width equal to or greater than a width of the roll paper. As illustrated in FIG. 1, this recording device 1 generally includes a housing 106, a head unit 100, first to fourth recording heads 101 corresponding to, for example, four colors CMYK, a scanner unit 102, a line scanner 103, and a transport roller 104. Then, roll paper 105 used as the recording medium is nipped by the pair of transport rollers 104 and transported in a direction of the arrow, and is sequentially subject to recording directly under each of the first to fourth recording heads 101.

### Configuration of Recording Head

A known method for ejecting ink from nozzles in the recording head 101 is to generate pressure in a pressure chamber using a piezoelectric element as an ejection energy generating element, and eject the liquid in the pressure chamber from a nozzle formed at one end of the pressure chamber using that pressure. The recording device 1 records using ink ejected from the nozzles of the recording head 101. In such a recording head 101, each piezoelectric element has an electrical contact and is connected to an integrated circuit that generates a drive signal, and ejection is performed by driving the piezoelectric element with the drive signal.

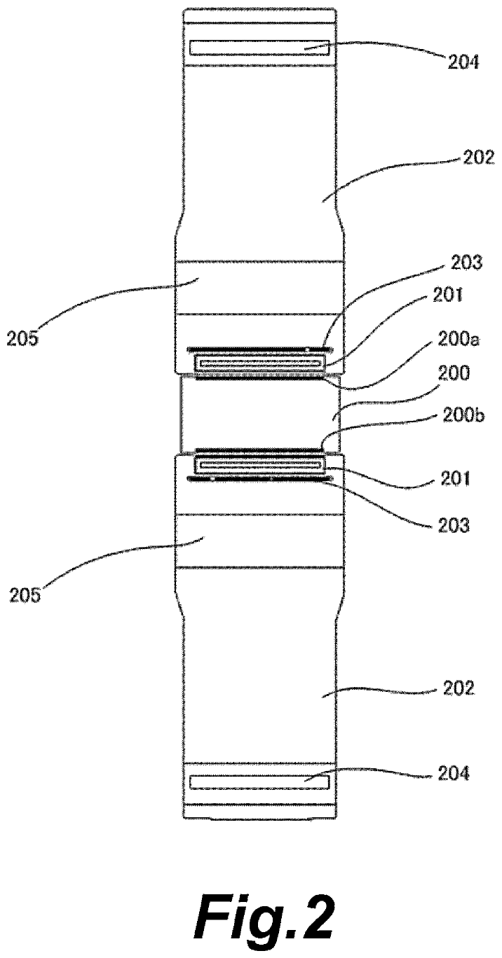

FIG. 2 is a schematic diagram of a unit 209 combining a piezoelectric element substrate 200, a drive element selection unit 201, and a flexible electrical wiring substrate 202. The piezoelectric element substrate 200 has a first terminal 200a and a second terminal 200b, which are respectively electrically connected to terminals (not illustrated) provided on the drive element selection units 201 mounted on the flexible electrical wiring substrates 202. The flexible electrical wiring substrate 202 has a selection unit side terminal 203, which is electrically connected to a wiring substrate side terminal (not illustrated) provided on the drive element selection unit 201.

The flexible electrical wiring substrate 202 includes a capacitor area 205 for mounting a power supply bypass capacitor for the drive element selection unit 201, and a head substrate connection unit 204 for connecting to a head substrate (not illustrated).

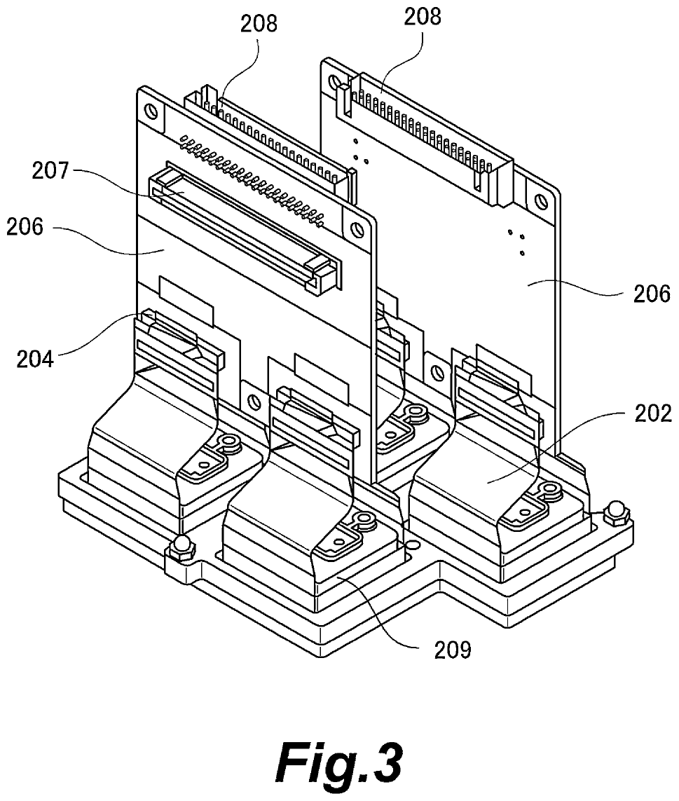

FIG. 3 is a schematic diagram of the recording head 101. One recording head 101 is composed of four units 209. Each unit 209 is electrically connected to a head substrate 206 by the head substrate connection unit 204. The head substrate 206 has a signal connection unit 207 and a drive signal connection unit 208 that are connected to a main body of the recording device 1.

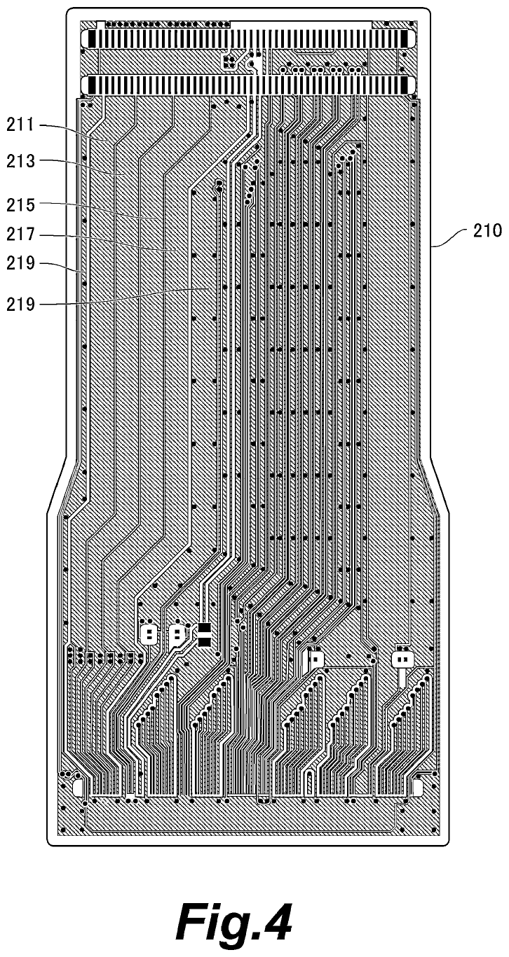

FIG. 4 illustrates wiring of a first layer of the flexible electrical wiring substrate 210. A first drive signal wiring 211, a third drive signal wiring 213, a fifth drive signal wiring 215, and a seventh drive signal wiring 217 all have approximately the same wiring width. Drive signal return current lines 219 are respectively arranged on a side of the first drive signal wiring 211 opposite the third drive signal wiring 213, and on a side of the seventh drive signal wiring 217 opposite the fifth drive signal wiring 215.

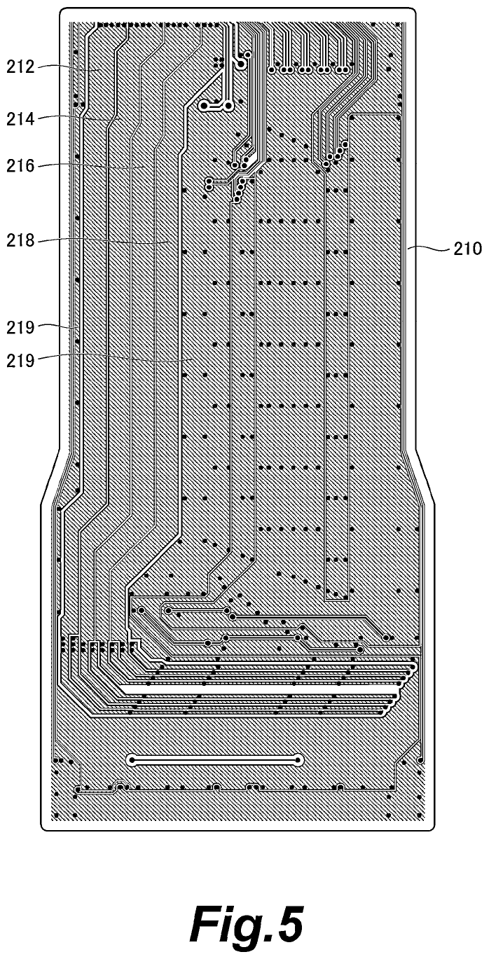

FIG. 5 illustrates wiring of a second layer of the flexible electrical wiring substrate 210. A second drive signal wiring 212, a fourth drive signal wiring 214, a sixth drive signal wiring 216, and an eighth drive signal wiring 218 all have approximately the same wiring width. Drive signal return current lines 219 are respectively arranged on a side of the second drive signal wiring 212 opposite the fourth drive signal wiring 214, and on a side of the eighth drive signal wiring 218 opposite the sixth drive signal wiring 216.

### Description of Piezoelectric Element Drive Method and Piezoelectric Element Drive Signal

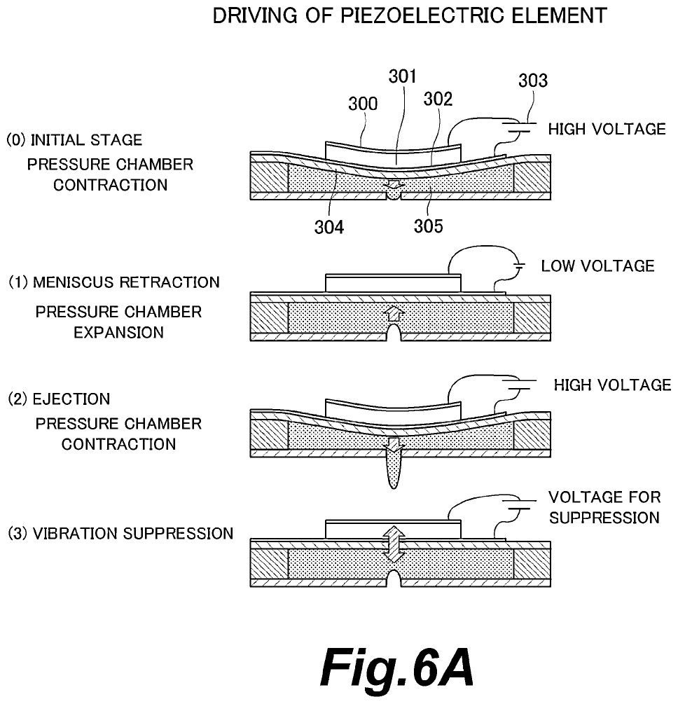

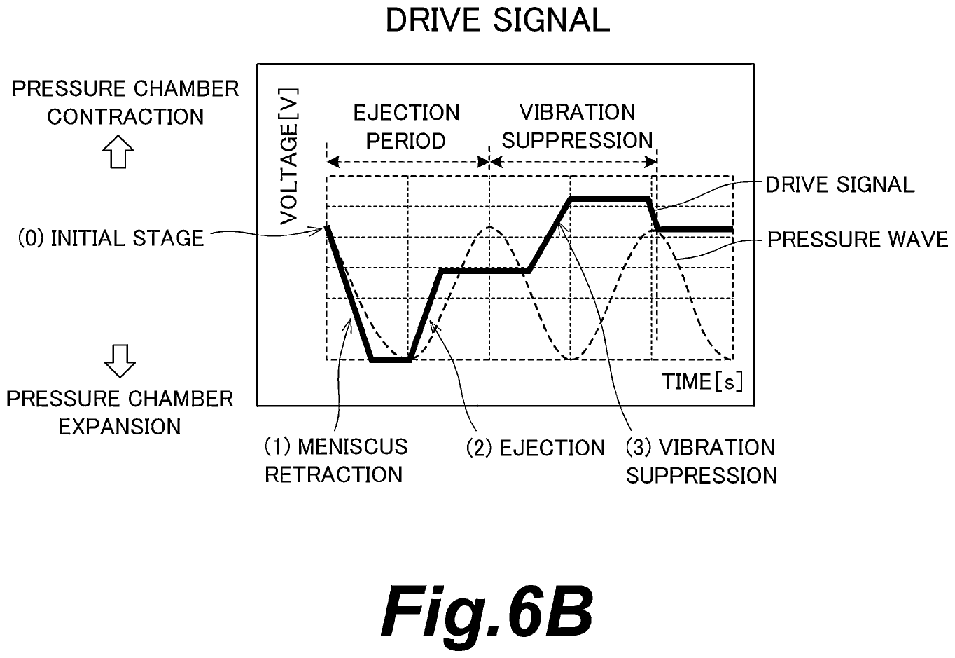

A method of driving a piezoelectric element 301 and a drive signal applied to the piezoelectric element 301 will be described using FIGS. 6A and 6B. Driving the piezoelectric element 301 involves steps (0) to (3) as illustrated in FIG. 6A, and applied voltage (drive signal) changes in these steps as illustrated in FIG. 6B. These will be described in order.
(0) In an initial state, a pressure chamber 304 is filled with ink 305, and a high voltage is applied between an upper electrode 300 and a lower electrode 302 of the piezoelectric element 301 from a voltage source 303, causing the pressure chamber 304 to contract.
(1) The voltage of the voltage source 303 is lowered to expand the pressure chamber 304 and draw in the ink 305. In this case, a sinusoidal pressure wave is generated in the pressure chamber 304 by the piezoelectric element 301.
(2) The voltage of the voltage source 303 is increased in synchronization with the pressure wave generated in (1) above, causing the pressure chamber 304 to contract and eject the ink 305.
(3) After (2) above, the piezoelectric element 301 continues to vibrate mechanically. To cancel this mechanical vibration and stop the piezoelectric element 301, the voltage of the voltage source 303 is increased again.

One ejection operation is performed through the above steps (0) to (3), and the series of voltage changes of the voltage source 303 described above is the waveform of the drive signal to be applied to the piezoelectric element 301.

### Functional Configuration of Recording Device

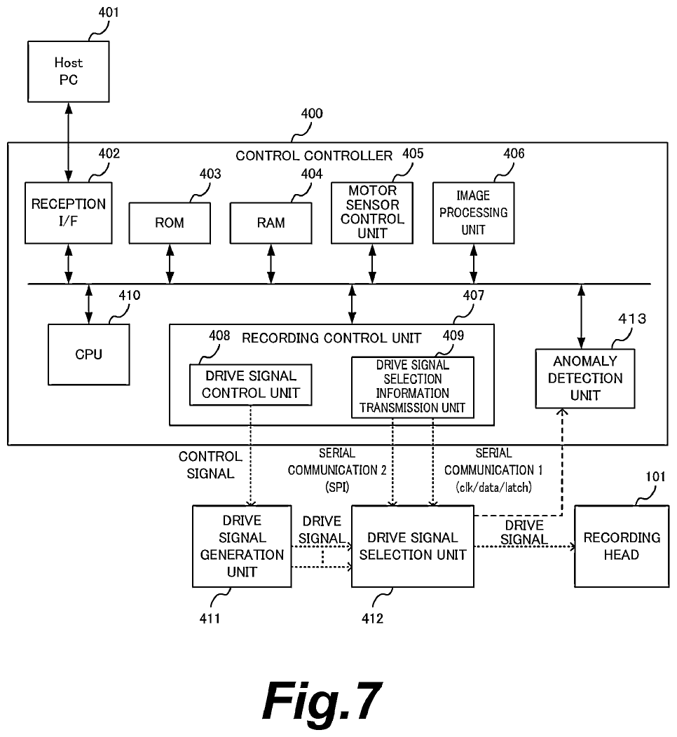

A functional configuration of the recording device 1 will be described. FIG. 7 is a block diagram illustrating the functional configuration of the recording device 1.

A Host PC 401 transmits print instructions and print data to a control controller 400. The control controller 400 that controls the recording device 1 has a reception I/F 402 that communicates with the Host PC 401, a CPU 410, and a ROM 403 that stores programs that operate the CPU 410. The control controller 400 also has a RAM 404 that executes programs and temporarily stores various data, and a motor sensor control unit 405 that controls the motor sensor in the recording device 1. The control controller 400 also has an image processing unit 406 that performs image processing on the print data sent from the Host PC 401 through the reception I/F 402, and a recording control unit 407 that controls the recording head 101 based on the data processed by the image processing unit 406.

The image processing unit 406 generates raster image data that can be printed using the print data received from the Host PC 401, and converts it into image data for each ink color such as CMYK that can be processed by the recording control unit 407 and outputs it. The recording control unit 407 consists of a drive signal control unit 408 and a drive signal selection information transmission unit 409. The drive signal control unit 408 transmits a control signal for generating a drive signal to a drive signal generation unit 411. The drive signal selection information transmission unit 409 transmits drive signal selection information to a drive signal selection unit 412 via serial communication 1.

The drive signal generation unit 411 outputs a plurality of drive signals to the drive signal selection unit 412 based on the control signal transmitted from the drive signal control unit 408. The drive signal selection unit 412 selects the plurality of drive signals input from the drive signal generation unit 411 based on the drive signal selection information transmitted from the drive signal selection information transmission unit 409, and the drive signal selection unit 412 then inputs the drive signal to the piezoelectric element 301 corresponding to the nozzle in the head unit 100. When the voltage of the drive signal waveform is applied to the electrodes of the piezoelectric element 301, the piezoelectric element 301 between the electrodes is displaced, and the resulting ejection energy is used to eject ink from the nozzle.

The serial communication 1 between the drive signal selection information transmission unit 409 and the drive signal selection unit 412 is composed of a clk signal, a data signal, and a latch signal. Information is transmitted on a data signal in synchronization with the clk signal, and information is transmitted in units of latch signals.

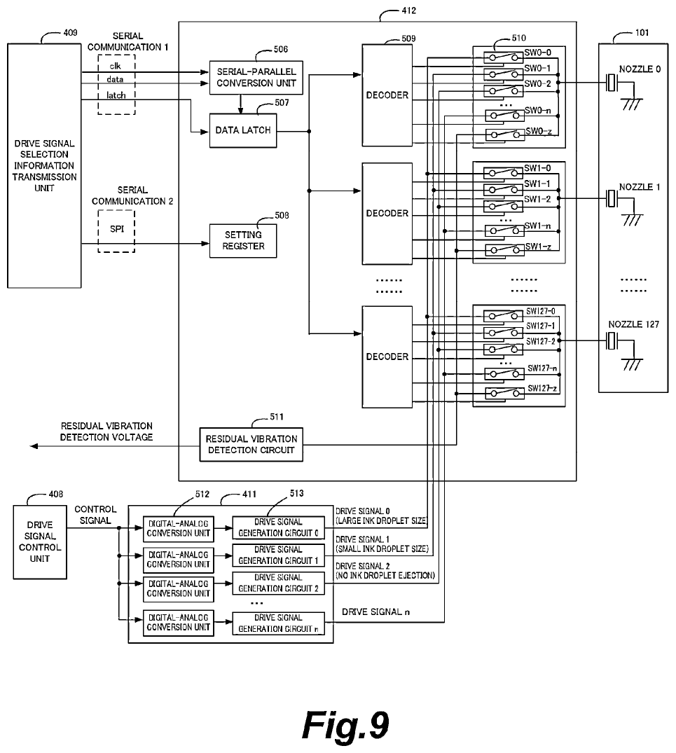

Serial communication 2 between the drive signal selection information transmission unit 409 and the drive signal selection unit 412 is used to set various setting information for the operation of the drive signal selection unit 412 with respect to a setting register 508 (see FIG. 9) inside the drive signal selection unit 412. A widely known communication protocol such as Serial Peripheral Interface (SPI) is used, but the communication method is not limited to this.

An anomaly detection unit 413 acquires the residual vibration voltage of the piezoelectric element 301, which is detected and amplified by a residual vibration detection circuit 511 described below, from the drive signal selection unit 412, and performs anomaly detection of an ejection unit having the piezoelectric element 301 based on the residual vibration voltage.

The recording head 101 is composed of nozzles with a mechanism for ejecting ink and the piezoelectric elements 301 corresponding to the nozzles, and ejects ink by inputting drive signals to the piezoelectric elements 301 corresponding to the nozzles. Here, the recording head 101 is assumed to be composed of 128 nozzles and the piezoelectric elements 301 corresponding to the nozzles. The number of nozzles is one example and is not limited to this.

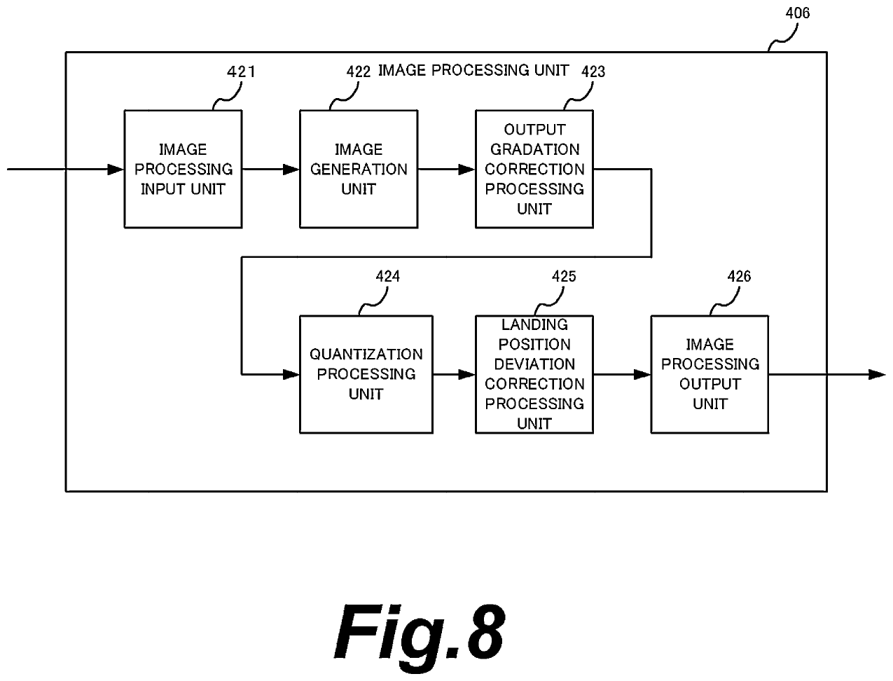

FIG. 8 is a diagram illustrating details of the processing content of the image processing unit 406 in FIG. 7. An image processing input unit 421 takes in print data and outputs it to an image generation unit 422. The image generation unit 422 uses the print data to convert it into CMYK data of a resolution recordable by the recording head 101 and outputs it. An output gradation correction processing unit 423 performs correction processing corresponding to the output characteristics of the ink.

A quantization processing unit 424 performs processing to convert 8-bit to 16-bit gradation data into gradations that can be expressed by the nozzles of the recording head 101. Typically, error diffusion or dithering is used to convert the data to N-value data, and the gradation is converted to 1-bit to 4-bit image data. A landing position deviation correction processing unit 425 shifts the data on a pixel basis to correct the landing position deviation for each nozzle in image resolution units. An image processing output unit 426 performs processing to output results of image processing.

### Description of Drive Signal Selection Unit

The drive signal selection unit 412 will be described using FIG. 9. Data transmitted from the drive signal selection information transmission unit 409 via the serial communication 1 (clk/data/latch) is received by a serial-parallel conversion unit 506 and held in a data latch 507, starting from the input timing of the latch signal. The held drive signal selection information is input to a decoder 509.

In addition, the drive signal generation unit 411 is also composed of a plurality of digital-analog conversion units 512 and a plurality of drive signal generation circuits 513. The digital-analog conversion units 512 receive control signals from the drive signal control unit 408. The drive signal generation circuit 513 receives the output analog signal from the digital-analog conversion unit and generates a drive signal.

The generated drive signal is input to a switch group 510 in the drive signal selection unit 412 mounted on the flexible electrical wiring substrate 202 through the head substrate 206 and the flexible electrical wiring substrate 202. The switch group 510 is composed of a plurality of switches SWx-y (x corresponds to the nozzle number and y corresponds to the drive signal number), and selects a drive signal from a plurality of drive signals based on the decode information of the decoder 509 to drive the piezoelectric element 301 corresponding to the nozzle.

The drive signal generation unit 411 is a generation unit that generates a plurality of drive signals corresponding to a plurality of drive patterns of the piezoelectric element 301. The plurality of drive patterns are, for example, large ink droplet size, small ink droplet size, no ink droplet ejection, and the like. The drive signal selection information transmission unit 409 is a designation unit that designates a drive signal for driving the piezoelectric element 301 from the plurality of drive signals generated by the drive signal generation unit 411. The drive signal selection unit 412 is a switch unit that outputs to the piezoelectric element 301 the drive signal designated by the drive signal selection information transmission unit 409 from the plurality of input drive signals.

The recording head 101 is, for example, made up of 128 nozzles and a piezoelectric element 301 corresponding to each nozzle, and there are as many decoders 509 and switch groups 510 as there are nozzles.

### Description of Serial Communication 1

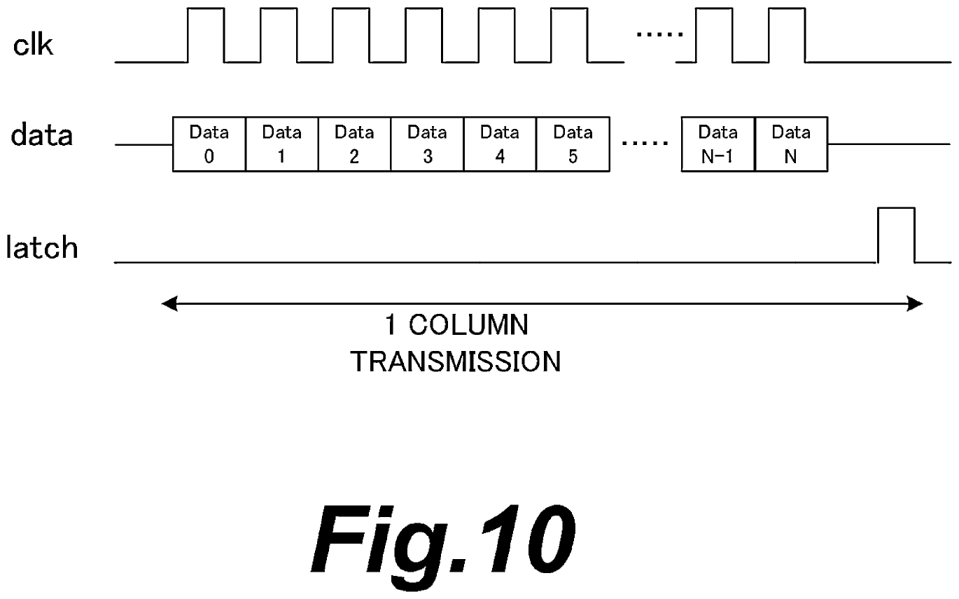

FIG. 10 illustrates contents of the serial communication 1 output from the drive signal selection information transmission unit 409. The data signal is transmitted in synchronization with the clk signal, and the latch signal indicates the end of one transmission.

The data signal does not need to be one line and the number of the data signals can be increased in balance with the clk signal frequency to keep up with the ink ejection frequency. Here, communication is performed so that data for one column, that is, data for the number of nozzles x drive signal selection information, can be transmitted between latch signals. For example, when there are four types of drive signals and the number of nozzles is 128, 128×2 bits (4 selections) of data will be transmitted. When there is a residual vibration detection switch, described below, there are 4 types+1 residual vibration detection=5 states, so 128×3 bits (5 selections) of data will be transmitted.

### Drive Signal Selection Unit Timing Chart

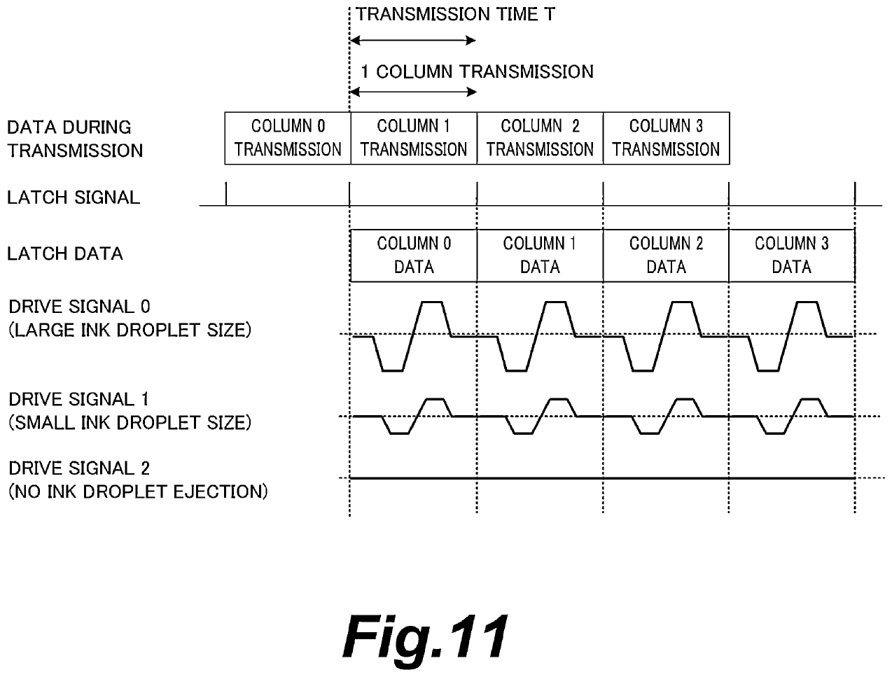

FIG. 11 illustrates a relationship between the data of the serial communication 1 and the drive signals. Drive signal selection information for one column (for all nozzles) is transferred between latch signals, and the received data is stored in the data latch 507 in FIG. 9, starting from the latch signal. Based on the stored data, the four input drive signals are selected for each nozzle and applied to the piezoelectric element 301 corresponding to the nozzle. Drive signals that can achieve the desired ink droplet states, such as large ink droplet size, small ink droplet size, or no ink droplet ejection, are assigned to the four drive signal generation circuits 513.

### Description of Drive Signal Generation Circuit

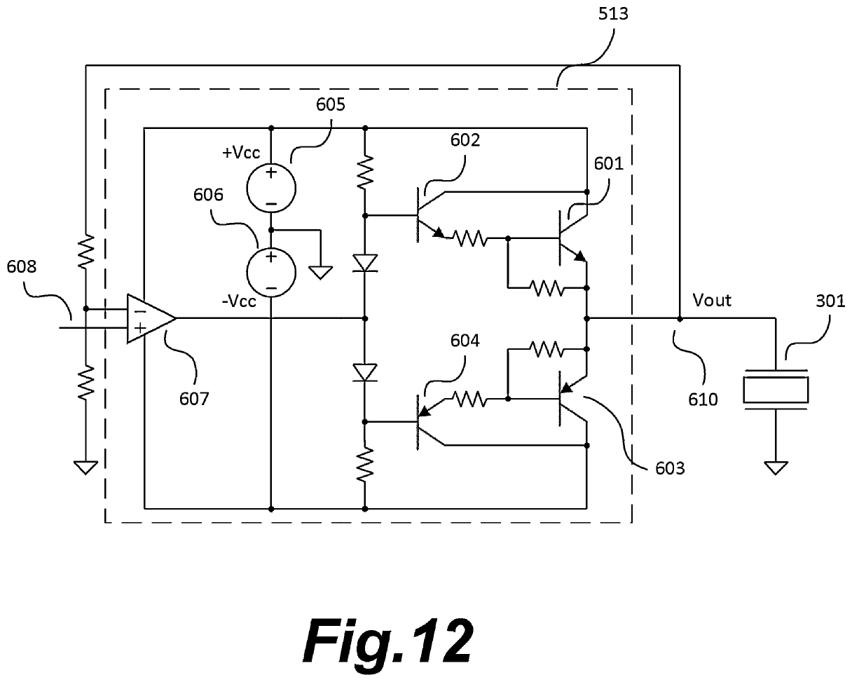

FIG. 12 is a diagram illustrating the drive signal generation circuit 513 that generates a drive signal. The drive signal generation circuit 513 is a so-called amplifier circuit, and amplifies the voltage and current of an analog signal 608 supplied to a non-inverting input terminal of an operational amplifier 607.

The drive signal generation circuit 513 is composed of transistors 601 and 602 connected in a Darlington configuration on the high side, transistors 603 and 604 connected in a Darlington configuration on the low side, and the operational amplifier 607. The transistors 601 and 602 are npn transistors, and the transistors 603 and 604 are pnp transistors. Base terminals of the transistors 602 and 604 are connected to an output terminal of the operational amplifier 607 via diodes, and emitter terminals of the transistors 601 and 603 are connected to the piezoelectric element 301 via switches SWx-n (not illustrated). Reference symbols 605 and 606 indicate power supply voltages.

In the above configuration, when the analog signal 608 is input to the drive signal generation circuit 513, the voltage of the analog signal 608 is amplified in the operational amplifier 607. Next, the current is amplified by the transistors 601 and 602 and the transistors 603 and 604. The piezoelectric element 301 is driven by a drive signal 610, the voltage and current of which have been amplified, causing ink to be ejected.

### Description of Residual Vibration Detection Circuit

Of the switches SWx-y included in the switch group 510 in FIG. 9, switches SWx-0 to SWx-n are switches for applying a drive signal to the piezoelectric element 301 corresponding to the nozzle. On the other hand, switches SWx-z are switches for supplying the residual vibration voltages generated in the piezoelectric elements 301 due to the residual vibration after the piezoelectric elements 301 are driven to the residual vibration detection circuits 511. The residual vibration detection circuit 511 is a detection unit that detects the residual vibration voltage caused by the residual vibration generated in the piezoelectric element 301 after the piezoelectric element 301 is driven by a designated drive signal. The residual vibration detection circuit 511 has an amplifier unit that amplifies and outputs the detected residual vibration voltage.

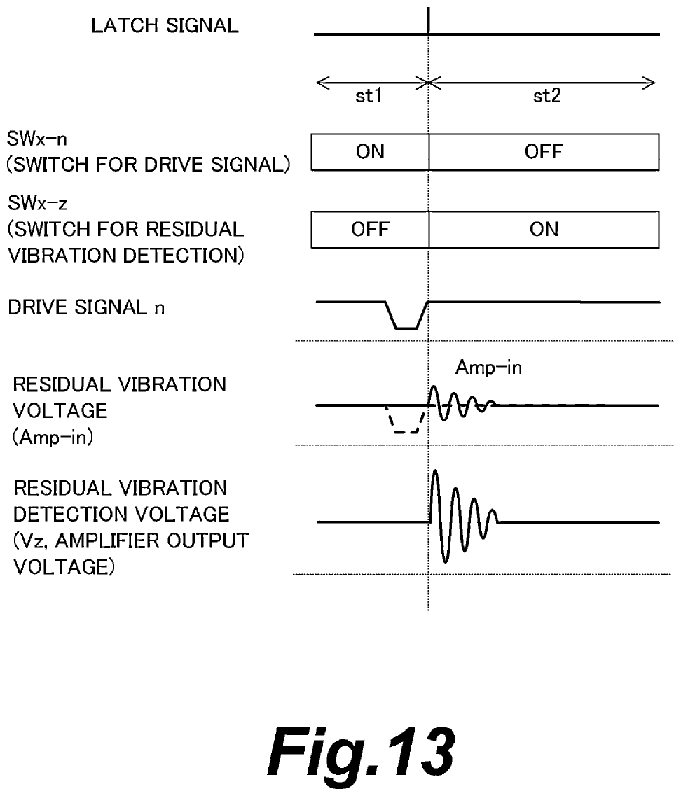

As illustrated in FIG. 13, a drive signal is applied to the piezoelectric element 301, driving the piezoelectric element 301 (st1 section). Then, the piezoelectric element 301 is disconnected from the drive signal. A vibration voltage like Amp-in in FIG. 13 then appears in the piezoelectric element 301. This is called a residual vibration voltage, which is the mechanical vibration remaining in the piezoelectric element 301 converted into voltage by the piezoelectric effect (st2 section). Anomalies in each nozzle can be detected by detecting and analyzing the residual vibration voltage.

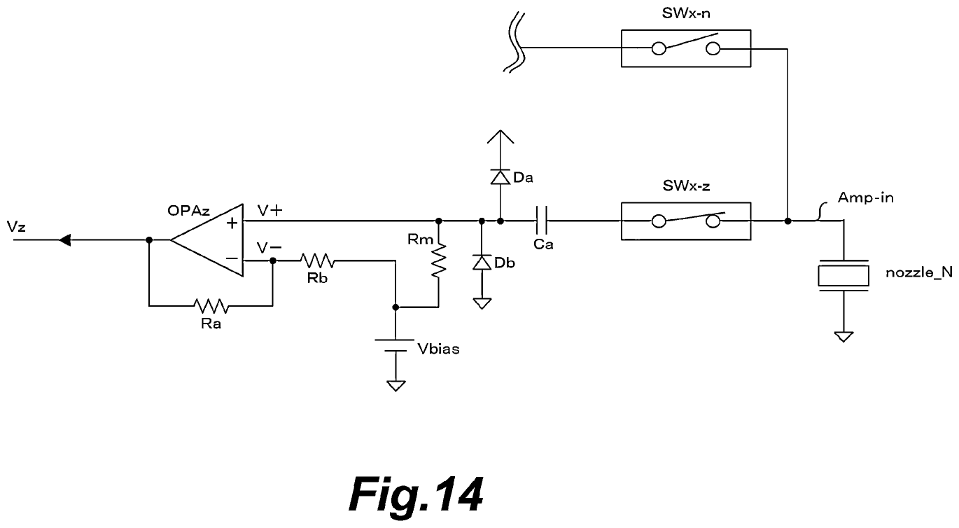

Here, for comparison with the embodiment, details of a residual vibration detection circuit 511 according to a comparative example are described in FIG. 14. In FIG. 14, the residual vibration voltage Amp-in is supplied to a non-inverting input terminal V+ of an operational amplifier OPAz via a switch SWx-z and a capacitor Ca. The V+ terminal of OPAz is also connected to a bias voltage Vbias via a resistor Rm. On the other hand, an inverting input terminal V− of OPAz is connected to a Vbias via a resistor Rb. Furthermore, the inverting input terminal V− of OPAz is connected to an output terminal of the operational amplifier OPAz via a resistor Ra.

In the above circuit, the residual vibration voltage Amp-in is amplified to become a residual vibration detection voltage Vz. The residual vibration detection voltage Vz is expressed by Expression (1).

$$[ Math . 1 ]$$

$${V}_{z} = \frac{{R}_{a} + {R}_{b}}{{R}_{b}} \cdot {Amp}_{- in} + {V}_{bias} \qquad Expression ( 1 )$$

The residual vibration detection voltage Vz is sent to the outside of the residual vibration detection circuit 511. The residual vibration detection voltage Vz is then converted into a digital signal by an analog-digital conversion device and analyzed by a logical operation element (not illustrated).

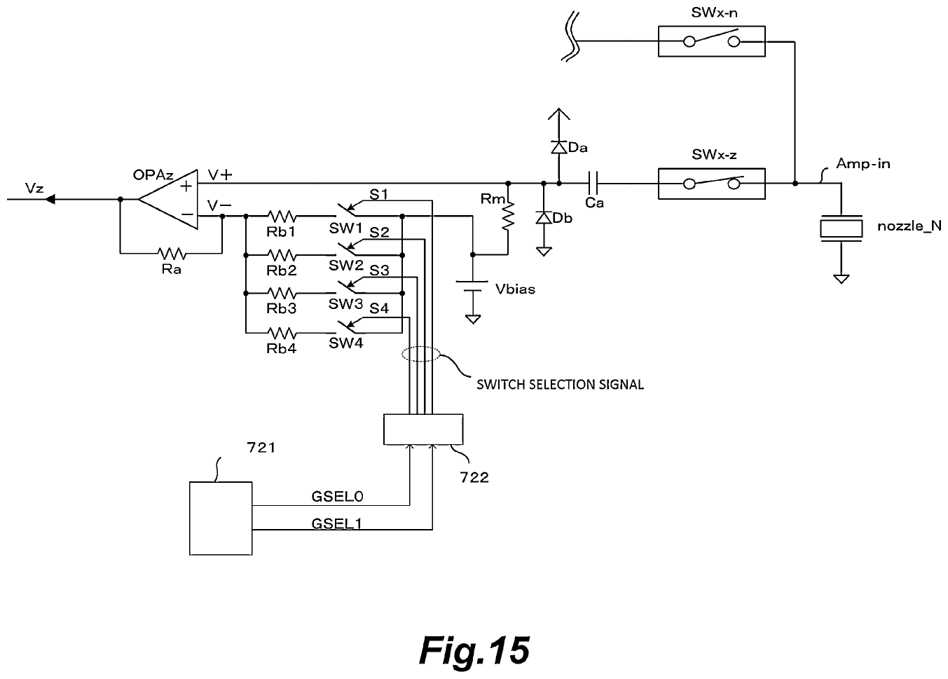

FIG. 15 is a diagram illustrating a configuration of the residual vibration detection circuit 511 in the embodiment. The circuit illustrated in FIG. 15 adds switches SW1 to SW4 to the circuit illustrated in FIG. 14, and changes the gain of the operational amplifier OPAz to be switchable by resistors Rb1 to Rb4 selected by the switches SW1 to SW4. The gain of the operational amplifier OPAz is a coefficient of the residual vibration voltage Amp-in in Expression (1) above, and is expressed by the following Expression (2).

$$[ Math . 2 ]$$

$$\frac{{R}_{a} + {R}_{b}}{{R}_{b}} = 1 + \frac{{R}_{a}}{{R}_{b}} \qquad Expression ( 2 )$$

For example, when Ra=10 kΩ and Rb=1 kΩ, the gain of the operational amplifier OPAz is 11 (times) according to Expression (2).

In FIG. 15, a first resistor Ra is connected between an inverting input terminal V− and an output terminal of the operational amplifier OPAz. One end of each of second resistors Rb1 to Rb4 is connected to the inverting input terminal V− of the operational amplifier OPAz, and the other ends of the second resistors Rb1 to Rb4 are respectively connected to one ends of the switches SW1 to SW4. Sides of the switches SW1 to SW4 that are not connected to the second resistors Rb1 to Rb4 are all connected to a bias voltage Vbias. The second resistors Rb1 to Rb4 are a plurality of resistors having different resistance values that are connected to the operational amplifier OPAz via the plurality of switches SW1 to SW4.

Here, the number of switches and resistors Rbn (n: natural number) between the inverting input terminal V− and the bias voltage Vbias selected by the switches is described as four, but the number of switches and resistors Rbn selected by the switches is not limited to four.

In the above, the switch SW1 is a switch that turns on when a switch selection signal S1, of switch selection signals S1 to S4 output from a switch selection unit 722, is at Hi level and turns off when the switch selection signal S1 is at Lo level. Similarly, the switches SW2 to SW4 are turned on and off by the switch selection signals S2, S3, and S4, respectively.

The switch selection unit 722 is a circuit that receives a setting signal GSELm (m=0, 1) output from a gain setting signal output unit 721, and sets any one of the switch selection signals S1 to S4 to Hi level and the others to Lo level depending on the input signal.

What is output as the setting signal GSELm (which switch is selected to determine the gain of the operational amplifier OPAz) is determined, for example, as follows. That is, it is determined based on the ink temperature detected by detection means (not illustrated), the ink type (ink color, composition), information (temperature, humidity, and the like) about the environment in which the recording device 1 is used, and the like. Specifically, the output data of the setting signal GSELm is determined by setting a predetermined value to the setting register 508.

The gain setting signal output unit 721 is a setting unit that sets the amplification factor of the residual vibration voltage in the residual vibration detection circuit 511. The switch selection unit 722 is a selection unit that selects any one of the plurality of switches SW1 to SW4 according to the amplification factor set by the gain setting signal output unit 721 and connects any one of the plurality of second resistors Rb1 to Rb4 to the operational amplifier OPAZ. As a result, the residual vibration detection circuit 511 amplifies the residual vibration voltage with an amplification factor (expressed in Expression (2)) according to a resistance ratio between the first resistor Ra and the second resistor Rbn selected by the switch selection unit 722. The gain setting signal output unit 721 sets the amplification factor according to at least any one of the type of ink, the temperature of the ink, and information about the environment in which the recording device 1 is used.

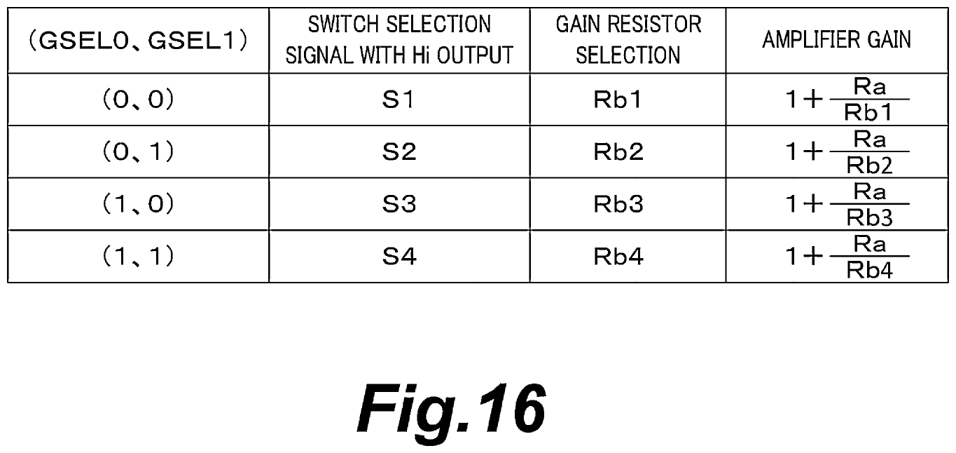

FIG. 16 is a diagram illustrating a correspondence relationship between the setting signal, the output signal (switch selection signals S1 to S4) of the switch selection unit 722, the resistor Rbn (n: natural number) selected by the switch selection signals S1 to S4, and the gain of the operational amplifier OPAz determined by the selected resistor Rbn. In the embodiment, the setting signal is a combination of GSEL0 and GSEL1. One of the four switches is selected using 2-bit input data, and as a result, one resistor Rbn (n: an integer from 1 to 4 here) is selected to be connected to the inverting input terminal of the operational amplifier OPAz. By selecting the resistor Rbn, the gain of the operational amplifier OPAz can be switched between four stages as illustrated in FIG. 16.

In the embodiment, an example is given where the number of selectable switches is four, so the required setting signal GSELm (m: integer equal to or greater than 0) is 2 bits (GSEL0 and GSEL1). However, the number of (number of bits) setting signals GSELm increases or decreases depending on the number of (=number of switches) switch selection signals. For example, when the number of GSELm is three (3 bits), the number of selectable switches is eight.

According to the present disclosure, it is possible to provide a recording device that is simply configured and capable of switching the amplification factor of a circuit that amplifies the residual vibration voltage caused by the residual vibration after driving of a piezoelectric element.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-203914, filed on Dec. 1, 2023, which is hereby incorporated by reference herein in its entirety.

What is claimed is:

1. A recording device including a piezoelectric element and a recording head ejecting liquid by driving the piezoelectric element, and performing recording by the liquid ejected by the recording head, the recording device comprising:
an amplifier unit amplifying and outputting residual vibration voltage caused by residual vibration generated in the piezoelectric element after the piezoelectric element is driven by a drive signal; and
a setting unit setting an amplification factor of the residual vibration voltage by the amplifier unit, wherein
the amplifier unit includes,
an operational amplifier,
a first resistor connected to the operational amplifier,
a plurality of switches, and
a plurality of second resistors having different resistance values and connected to the operational amplifier via each of the plurality of switches,
the recording device includes a selection unit selecting any one of the plurality of switches in accordance with the amplification factor set by the setting unit so as to connect any one of the plurality of second resistors to the operational amplifier, and
the amplifier unit amplifies the residual vibration voltage with an amplification factor according to a resistance ratio between the first resistor and the second resistor selected by the selection unit.

2. The recording device according to claim 1, wherein
an anomaly in the recording head is detected based on the residual vibration voltage amplified by the amplifier unit.

3. The recording device according to claim 1, wherein
the setting unit sets the amplification factor in accordance with at least any of a type of the liquid, a temperature of the liquid, and information on environment in which the recording device is used.

4. The recording device according to claim 1, further comprising:
a generation unit generating a plurality of drive signals according to a plurality of drive patterns of the piezoelectric element.

5. The recording device according to claim 1, further comprising:
a designation unit designating a drive signal for driving the piezoelectric element from among the plurality of drive signals; and
a switch unit outputting a drive signal designated by the designation unit from among the plurality of input drive signals to the piezoelectric element.
